(19) United States
(12) Patent Application Publication
(10) Pub. No.: US 2020/0288675 A1
(43) Pub. Date: Sep. 17, 2020

(54) WEARABLE SENSOR DEVICE TO ASSIST VISION-IMPAIRED ANIMAL

(71) Applicant: Shonna Auld, Seattle, WA (US)

(72) Inventor: Shonna Auld, Seattle, WA (US)

(21) Appl. No.: 16/733,086

(22) Filed: Jan. 2, 2020

Related U.S. Application Data
(60) Provisional application No. 62/787,866, filed on Jan. 3, 2019.

(51) Int. Cl. A01K 29/00; A01K 27/00

(52) U.S. Cl. CPC A01K 29/00; G01V 8/10; A01K 27/002

(57) ABSTRACT

A wearable sensor device to assist a vision-impaired animal in navigating its surroundings includes a harness to be worn by the animal, a plurality of proximity sensors coupled to the harness, and a plurality of output devices coupled to the harness. The proximity sensors and the output devices can overlay the shoulders, the sides, and the chest of the animal when the animal wears the device. The proximity sensors can face forward, to the sides of the animal, and horizontally. The device includes a control unit to receive signals from the sensors, process the signals, and transmit signals to the output devices.

### BACKGROUND

### Technical Field

The present disclosure relates generally to devices that can be worn by a vision-impaired animal, especially a dog, to provide assistance in navigating its surroundings.

### Description of the Related Art

Several options are available to an owner of a blind or vision-impaired animal, such as a dog, to assist the animal in navigating its surroundings. In some cases, a vision impaired animal can to some extent be trained to navigate certain environments by memory, but such approaches are quite limited. In other cases, the animal can be provided with a physical device that extends around at least a portion of the animal's body, such as the animal's head, to alert the animal to the fact that they are approaching a wall or other object, and to soften an impact with the wall or other object. Such approaches are also quite limited and still fail to prevent undesirable impacts. Thus, some attempts have been made to design systems including proximity sensors to be worn by a vision impaired animal and alert the animal to their proximity to other objects before an impact occurs. Nevertheless, such systems suffer from various drawbacks, and further improvements are still desired.

### BRIEF SUMMARY

A wearable sensor device to assist a vision-impaired dog in navigating its surroundings may be summarized as comprising: a harness; a first proximity sensor coupled to the harness at a first position that overlays a left shoulder of the dog and such that the first proximity sensor faces forward when the dog wears the harness; and a second proximity sensor coupled to the harness at a second position that overlays a right shoulder of the dog and such that the second proximity sensor faces forward when the dog wears the harness.

The first and second proximity sensors may be coupled to the harness such that the first and second proximity sensors are oriented horizontally when the dog wears the harness. The wearable sensor device may further comprise: a first output device coupled to the harness adjacent to the first proximity sensor; and a second output device coupled to the harness adjacent to the second proximity sensor. The wearable sensor device may further comprise: a third proximity sensor coupled to the harness at a third position that overlays a left side of a torso of the dog and such that the third proximity sensor faces away from the left side of the dog when the dog wears the harness; and a fourth proximity sensor coupled to the harness at a fourth position that overlays a right side of the torso of the dog and such that the fourth proximity sensor faces away from the right side of the dog when the dog wears the harness.

The third and fourth proximity sensors may be coupled to the harness such that the third and fourth proximity sensors are oriented horizontally when the dog wears the harness. The wearable sensor device may further comprise: a third output device coupled to the harness adjacent to the third proximity sensor; and a fourth output device coupled to the harness adjacent to the fourth proximity sensor. The wearable sensor device may further comprise: a fifth proximity sensor coupled to the harness at a fifth position that overlays a lower chest of the dog and such that the fifth proximity sensor faces forward and downward when the dog wears the harness. The fifth proximity sensor may be coupled to the harness such that the fifth proximity sensor is oriented 45 degrees downward of horizontal (towards the ground in front of the dog) when the dog wears the harness. The wearable sensor device may further comprise: a fifth output device coupled to the harness adjacent to the fifth proximity sensor.

### BRIEF DESCRIPTION OF THE SEVERAL VIEWS OF THE DRAWINGS

In the drawings, identical reference numbers identify similar elements or acts. The sizes and relative positions of elements in the drawings are not necessarily drawn to scale. For example, the shapes of various elements and angles are not necessarily drawn to scale, and some of these elements may be arbitrarily enlarged and positioned to improve drawing legibility. Further, the particular shapes of the elements as drawn are not necessarily intended to convey any information regarding the actual shape of the particular elements, and may have been solely selected for ease of recognition in the drawings.

FIG. 1 illustrates a schematic side view of a vision-impaired dog wearing a harness including a sensor device to assist the dog in navigating its surroundings.

FIG. 2 illustrates a schematic front view of a vision-impaired dog in a seated portion wearing the harness including the sensor device to assist the dog in navigating its surroundings.

### DETAILED DESCRIPTION

Persons of ordinary skill in the art will understand that the present disclosure is illustrative only and not in any way limiting. Other implementations and various combinations of the presently disclosed system and method readily suggest themselves to such skilled persons having the assistance of this disclosure.

This detailed description is intended to teach a person of skill in the art details for practicing aspects of the present teachings and is not intended to limit the scope of the claims. Therefore, combinations of features disclosed in the detailed description may not be necessary to practice the teachings in the broadest sense, and are instead taught merely to describe particularly representative examples of the present teachings.

In the description below, for purposes of explanation only, specific nomenclature is set forth to provide a thorough understanding of the present system and method. However, it will be apparent to one skilled in the art that these specific details are not required to practice the teachings of the present system and method.

Throughout the specification, claims, and drawings, the following terms take the meaning explicitly associated herein, unless the context clearly dictates otherwise. The term “herein” refers to the specification, claims, and drawings associated with the current application. The phrases “in one implementation,” “in another implementation,” “in various implementations,” “in some implementations,” “in other implementations,” and other variations thereof refer to one or more features, structures, functions, limitations, or characteristics of the present disclosure, and are not limited to the same or different implementations unless the context clearly dictates otherwise. As used herein, the term “or” is an inclusive “or” operator, and is equivalent to the phrases “A or B, or both” or “A or B or C, or any combination thereof,” and lists with additional elements are similarly treated. The term “based on” is not exclusive and allows for being based on additional features, functions, aspects, or limitations not described, unless the context clearly dictates otherwise. In addition, throughout the specification, the meaning of “a,” “an,” and “the” include singular and plural references.

Moreover, the various features of the representative examples and the dependent claims may be combined in ways that are not specifically and explicitly enumerated in order to provide additional useful implementations of the present teachings. It is also expressly noted that all value ranges or indications of groups of entities disclose every possible intermediate value or intermediate entity for the purpose of original disclosure, as well as for the purpose of restricting the claimed subject matter. It is also expressly noted that the dimensions and the shapes of the components shown in the figures are designed to help to understand how the present teachings are practiced, but not intended to limit the dimensions and the shapes shown in the examples. Additionally, the headings and Abstract provided herein are for convenience only and do not limit the scope or meaning of the implementations.

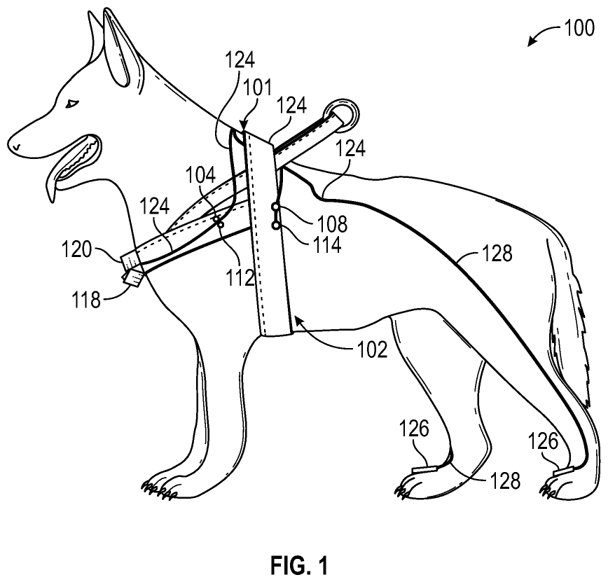

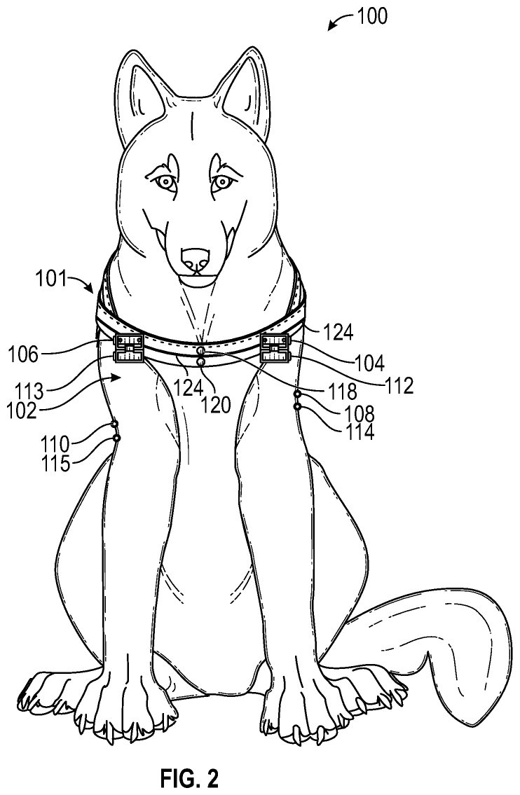

As used herein, terms such as “front,” “back,” “left,” “right”, “above,” “below,” “in front of,” and “behind” carry their ordinary meaning with respect to a vision-impaired animal such as a dog. FIGS. 1 and 2 illustrate schematic side and front views, respectively, of a vision-impaired dog 100 wearing a harness 102 that carries a sensor system 101 to assist the dog 100 in navigating its surroundings. The harness 102 can be a standard, commercially available harness designed to be worn by a dog. Various suitable harnesses are widely available.

As illustrated in FIGS. 1 and 2, in some implementations, the sensor system 101 includes a first proximity sensor 104 coupled to the harness 102 at a position above or overlaying the left shoulder of the dog 100 and a second proximity sensor 106 coupled to the harness 102 at a position above or overlaying the right shoulder of the dog 100. In other implementations, the sensor system 101 also includes a third proximity sensor 108 coupled to the harness 102 at a position overlaying the left side of the torso of the dog 100, a fourth proximity sensor 110 coupled to the harness 102 at a position overlaying the right side of the torso of the dog 100, and a fifth proximity sensor 118 coupled to the harness 102 at a position overlaying the lower chest of the dog 100, in addition to the first and second proximity sensors. In still other implementations, sensor system 101 includes a first proximity sensor 104 coupled to the harness 102 at a position above or overlaying the left shoulder of the dog 100, a second proximity sensor 106 coupled to the harness 102 at a position above or overlaying the right shoulder of the dog 100, and a fifth proximity sensor 118 coupled to the harness 102 at a position overlaying the lower chest of the dog 100.

The first, second, third, fourth, and fifth proximity sensors 104, 106, 108, 110, and 118 are infrared or photon proximity sensors. In other implementations, first, second, third, fourth, and fifth proximity sensors 104, 106, 108, 110, and 118 are standard, commercially available proximity sensors such as optical, laser-based (e.g., lidar), or sonar proximity sensors. Various suitable proximity sensors of such kinds are widely available. In some cases, light-based proximity sensors are advantageous because they are less likely than acoustic proximity sensors to affect the dog 100, and infrared proximity sensors are particularly advantageous due to their relatively low cost.

In some implementations, the sensor system 101 further includes a first output device 112 coupled to the harness 102 at a position above or overlaying the left shoulder of the dog 100 and adjacent to and below the first proximity sensor 104 and a second output device 113 coupled to the harness 102 at a position above or overlaying the right shoulder of the dog 100 and adjacent to and below the second proximity sensor 106. In other implementations, the sensor system 101 further includes a third output device 114 coupled to the harness 102 at a position overlaying the left side of the torso of the dog 100 and adjacent to and below the third proximity sensor 108, a fourth output device 115 coupled to the harness 102 at a position overlaying the right side of the torso of the dog 100 and adjacent to and below the fourth proximity sensor 110, and a fifth output device 120 coupled to the harness 102 at a position overlaying the front of the torso or the chest of the dog 100 and adjacent to and below the fifth proximity sensor 118, in addition to the first and second output devices.

In still other implementations, sensor system 101 includes a first output device 112 coupled to the harness 102 at a position above or overlaying the left shoulder of the dog 100 and adjacent to and below the first proximity sensor 104, a second output device 113 coupled to the harness 102 at a position above or overlaying the right shoulder of the dog 100 and adjacent to and below the second proximity sensor 106, and a fifth output device 120 coupled to the harness 102 at a position overlaying the front of the torso or the chest of the dog 100 and adjacent to and below the fifth proximity sensor 118. The first, second, third, fourth, and fifth output devices 112, 113, 114, 115, and 120 can be standard, commercially available output devices such as acoustic output devices including speakers, or tactile output devices configured to buzz or vibrate. In some cases, tactile output devices configured to buzz or to vibrate are advantageous because vision-impaired animals may also be hearing-impaired.

The sensor system 101 includes a power source 116, which can include a rechargeable battery such as a lithium-ion battery. The sensor system 101 also includes a control unit 122, which includes a computer having a microcontroller, a microprocessor, and/or a memory device. The control unit 122 is configured to receive, and includes instructions for receiving, signals and information from the various proximity sensors of the sensor system 101. The control unit 122 is also configured to perform, and includes instructions for performing, various operations on, or analyses of, such signals. The control unit 122 is also configured to output, and includes instructions for outputting, signals and commands to the various output devices of the sensor system 101. The control unit 122 includes antennas to transmit information, such as data regarding signals provided by the proximity sensors, and to receive information, such as software updates, wirelessly, such as over a WiFi connection, a Bluetooth connection, and/or a cellular connection.

For example, the control unit 122 may be communicatively coupled to a computing device, such as a smartphone, a tablet, a laptop, or a desktop computer, such as over one or more of the aforementioned wireless communication protocols or connections. Such a computing device may run or be configured to run one or more applications or apps configured to receive information, such as data regarding signals provided by the proximity sensors, from the control unit 122, and to transmit information, such as software updates, to the control unit 122. The control unit 122 also may include a GPS module to receive GPS signals and output signals representative of the location of the control unit 122. Such signals can be used in some implementations to monitor the location of the dog 100. In some implementations, the GPS module communicates with the one or more applications on the smartphone using W-Fi, cellular service, Bluetooth, or other communication protocols.

Additionally, the one or more applications or apps running on the computing device (e.g., smartphone) may be configured to receive instructions or other data that is used by the control unit 122 to control the movement of the dog 100 or other animal wearing the harness 102. For example, in some implementations, the control unit 122 may receive instructions via the application running on the smartphone to prevent the dog from entering one or more rooms. This may be achieved by programming the control unit 122 to send output signals to the dog 100 via the output devices 112, 113 that there is a “virtual wall” in front of the entrance to the one or more rooms. In the same manner, the the control unit 122 may receive instructions via the application running on the smartphone to prevent the dog from leaving the yard of the owner of the dog 100. Again, may be achieved by programming the control unit 122 to send output signals to the dog 100 via the output devices 112, 113 that there is a “virtual fence” in around the outside of the yard of the owner of the dog 100.

The sensor system 101 includes wiring 124 to electronically and communicatively couple its various components to one another. For example, the wiring 124 can electronically couple the battery 116 to, and thereby provide electrical power to, the control unit 122, the proximity sensors 104, 106, 108, 110, and 118, and the output devices 112, 113, 114, 115, and 120. The wiring 124 can also communicatively couple the proximity sensors 104, 106, 108, 110, and 118 to the control unit 122 so that signals generated by the proximity sensors representative of a proximity of objects to the proximity sensors can be transmitted from the proximity sensors to the control unit 122. The wiring 124 can also communicatively couple the control unit 122 to the output devices 112, 113,114, 115, and 120, so that signals generated by the control unit 122 representative of a desired strength or magnitude or intensity of an output to be generated by the output devices can be transmitted from the control unit 122 to the output devices 112, 113,114, 115, and 120.

In operation, the harness 102 can be installed on the dog 100 such that the first and second proximity sensors 104 and 106 are oriented forward and horizontally or substantially horizontally, so that they provide respective signals indicative of the proximity of objects in front of the dog 100. For example, the first proximity sensor 104 can generate a signal indicative of the proximity of objects with respect to the left shoulder of the dog 100 and the second proximity sensor 106 can generate a signal indicative of the proximity of objects with respect to the right shoulder of the dog 100. These signals can be communicated through the wiring 124 to the control unit 122. The control unit can receive these signals, process the signals to determine desired strengths or magnitudes or intensities of outputs to be generated by the respective first and second output devices, and generate signals indicative of such strengths. These signals can be communicated through the wiring 124 to the first and second output devices. The first and second output devices can then generate output, such as vibration, in accordance with the signals and the desired strengths. In some implementations of the sensor system 101, the sensor system 101 only includes the first and second proximity sensors 104 and 106 (i.e., the sensor system 101 does not include any of the third, fourth, and fifth proximity sensors 108, 110, and 118).

In operation, the harness 102 can also be installed on the dog 100 such that the third and fourth proximity sensors 108 and 110 are oriented outward to the sides of the torso of the dog 100 and horizontally or substantially horizontally, so that they provide respective signals indicative of the proximity of objects on each side of the dog 100. For example, the third proximity sensor 108 can generate a signal indicative of the proximity of objects with respect to the left side of the torso of the dog 100 and the fourth proximity sensor 110 can generate a signal indicative of the proximity of objects with respect to the right side of the torso of the dog 100. These signals can be communicated through the wiring 124 to the control unit 122. The control unit can receive these signals, process the signals to determine desired strengths or magnitudes or intensities of outputs to be generated by the respective third and fourth output devices, and generate signals indicative of such strengths. These signals can be communicated through the wiring 124 to the third and fourth output devices. The third and fourth output devices can then generate output, such as vibration, in accordance with the signals and the desired strengths. In some implementations of the sensor system, the sensor system 101 only includes the first, second, third, and fourth proximity sensors 104, 106, 108, and 110 (i.e., the sensor system 101 does not include the fifth proximity sensor 118).

By providing first and second proximity sensors 104 and 106 that are oriented forward and horizontally or substantially horizontally on the left and right shoulders of the dog 100, the sensor system 101 of the harness 102 provides a technical improvement over other configurations that merely use a single central sensor in the chest of the dog 100 or other animal wearing the harness. A harness with a single sensor only provides a binary (i.e., clear or not clear) reading to an animal wearing the harness. In contrast, implementations of the sensor system 101 of the harness 102, can provide much more detailed information to the dog 100, including: (1) all clear; (2) clear to the right, obstruction to the left; (3) clear to the left, obstruction to the right; or (4) obstructions to the left and the right. In the “clear to the right, obstruction to the left” situation, the dog 100 wearing the harness 102 with the sensor system 101 may be provided with information (e.g., vibration, sound, or the like at the corresponding output device) informing it that a slight turn to the right is sufficient to avoid the obstruction. In the “clear to the left, obstruction to the right” situation, the dog 100 wearing the harness 102 with the sensor system 101 may be provided with information (e.g., vibration, sound, or the like at the corresponding output device) informing it that a slight turn to the left is sufficient to avoid the obstruction.

In some implementations where the proximity sensors provide variable levels of sensing (e.g., very close object sensed, somewhat close object sensed, mid-range object sensed, and the like), the dog 100 wearing the harness 102 with the sensor system 101 is provided with information (e.g., vibration, sound, or the like at the corresponding output device) informing it more specifically what degree of turn is sufficient to avoid the obstruction. In other implementations, larger or smaller numbers of levels of distance sensing may be provided by the proximity sensors of the sensor system 101.

In still other implementations, the proximity sensors are configured to send information to the output devices representing the level of distance being sensed on a sliding scale rather than at a finite number of fixed levels. This information representing the level of distance being sensed that is sent on a sliding scale to the output devices may then be used to generate output (e.g., vibration, sound, or the like at the corresponding output device) that is also on a sliding scale. For example, in one implementation the vibration produced by the relevant output device would become gradually stronger as the dog 100 approached an obstruction, and vibration produced by the relevant output device would become gradually weaker as the dog 100 moved away from an obstruction. In another implementation, the sound produced by the relevant output device would become gradually louder as the dog 100 approached an obstruction, and vibration produced by the relevant output device would become gradually softer as the dog 100 moved away from an obstruction.

If the implementation of the sensor system 101 of the harness 102 also includes third, and fourth proximity sensors 108, 110, then the dog 100 may also receive information informing it whether it may turn 90 degrees to the left (if there is an objection sensed to the right) or 90 degrees to the right (if there is an objection sensed to the left). In a situation where all four proximity sensors 104, 106, 108, 110 signal proximity alerts, the dog 100 knows that it has to back straight out from its current position.

In operation, the harness 102 can also be installed on the dog 100 such that the fifth proximity sensor 118 is oriented forward and downward, so that it provides a respective signal indicative of the proximity of the ground or floor descending lower or ascending higher (e.g., stairs up or down) in front of the dog 100. For example, the fifth proximity sensor 118 can generate a signal indicative of the proximity of the ground or floor in front of the dog 100. This signal can be communicated through the wiring 124 to the control unit 122. The control unit can receive this signal, process the signal to determine a desired strength, magnitude, or intensity of output to be generated by the respective fifth output device 120, and generate a signal indicative of such strength. This signal can be communicated through the wiring 124 to the fifth output device 120. The fifth output device 120 can then generate output, such as vibration, in accordance with the signal and the desired strength.

In some cases, the signal generated by the first proximity sensor 104, and only that signal, is used by the controller to control the operation of the first output device 112. Similarly, the signal generated by the second proximity sensor 106, and only that signal, is used by the controller to control the operation of the second output device. Similarly, the signal generated by the third proximity sensor 108, and only that signal, is used by the controller to control the operation of the third output device 114. Similarly, the signal generated by the fourth proximity sensor 110, and only that signal, is used by the controller to control the operation of the fourth output device. Similarly, the signal generated by the fifth proximity sensor 118, and only that signal, is used by the controller to control the operation of the fifth output device 120. Thus, the signal generated by each of the proximity sensors can be used to directly control the respective adjacent output device. In other implementations, the signals generated by the proximity sensors can be combined or used in any desired manner to control the operation of one or more of the output devices.

In some implementations, the strength of the output generated by an output device is increased by the control unit 122 in response to the signal from the respective adjacent proximity sensor indicating that a proximity of an object to the proximity sensor is increasing (i.e., as the object gets closer to the proximity sensor). Similarly, in such implementations, the strength of the output generated by the output device is decreased by the control unit 122 in response to the signal from the respective adjacent proximity sensor indicating that the proximity of the object to the proximity sensor is decreasing (i.e., as the object gets farther from the proximity sensor). In this regard, the dog 100 can receive intuitive tactile feedback indicative of the proximity of objects such as walls, people, vehicles, and the like, in front of its left and right shoulders. Positioning proximity sensors on the left and right shoulders of the dog 100 can be advantageous because the shoulders of the dog 100 typically move (e.g., up and down, side to side, forward and back, and by rotation) less than other parts of the dog 100, such as its head and its legs.

Positioning the proximity sensors on the shoulders of the dog 100 therefore allows the sensor system 101 to provide feedback to the dog indicative of the proximity of objects in front of the dog with relatively small variation resulting from incidental movement of its head and/or legs. Such feedback can assist the dog 100 in navigating its surrounding environment, such as by alerting it to the fact that it is about to walk into an object or wall.

In such an implementation, the dog 100 can also receive intuitive tactile feedback indicative of the proximity of objects to each of its sides. Such feedback can assist the dog 100 in knowing which way to turn when it is confronted with an object blocking its forward path. For example, the dog 100 can be trained to navigate as it pleases while it receives no tactile feedback from the output devices of the sensor system 101. The dog 100 can also be trained to stop its forward movement when it receives tactile feedback at its left shoulder, its right shoulder, or both of its shoulders. The dog 100 can also be trained to turn left once it has stopped moving forward if it receives no tactile feedback from the output device at its left side, and/or to turn right once it has stopped moving forward if it receives no tactile feedback from the output device at its right side.

In this manner, the dog 100 can also receive intuitive tactile feedback indicative of the proximity of objects such as walls, people, vehicles, and the like, in front of its left and/or right shoulders. Positioning a proximity sensor on the lower chest of the dog 100 can be advantageous because it can provide feedback regarding the proximity of the ground level directly in front of the dog 100 and because it can assist the dog 100 in navigating rapid inclined and declines, such as by alerting it to the fact that it is about to walk up stairs or down stairs.

In some implementations, the sensor system 101 can include one or more accelerometers 126 coupled to the hind legs and/or to the hind feet of the dog 100. In some implementations, the accelerometers 126 are operatively connected with the top surfaces of the hind feet of the dog 100. In other implementations, the accelerometers 126 are operatively connected with the inner side surfaces and/or the outer side surfaces of the hind feet of the dog 100. The accelerometers 126 can be communicatively coupled by the wiring 128 to the control unit 122, which can receive signals indicative of the accelerations of the hind legs and/or hind feet of the dog 100 as the dog 100 moves about its surrounding environment. Such information can be used by the control unit 122, or downloaded from the control unit 122 and used by another computing device, to monitor and analyze the gait and other characteristics of the movement of the dog 100. Such information can also be used to detect, diagnose, and/or monitor the neurological health or neurological problems facing the dog 100, which often manifest themselves in characteristic changes to gait and other movements of the hind legs and/or hind feet of dogs.

In other implementations, the control unit 122 may determine that the dog 100 is not moving, or at rest, such as lying down. Such a determination may be based at least in part on signals provided by the accelerometers 126. Upon making such a determination, the control unit 122 can shut down, or put into a sleep mode, the entire sensor system 101 including the control unit 122, the proximity sensors, and the output devices. Shutting down the sensor system 101 in this manner can reduce power consumption and extend the overall lifetime of the battery 116. The control unit 122 may also determine that the dog 100 is no longer at rest. Such a determination may be based at least in part of signals provided by the accelerometers 126. Upon making such a determination, the control unit 122 can turn on, or wake from the sleep mode, the entire sensor system 101 including the control unit 122, the proximity sensors, and the output devices.

In still other implementations, the control unit 122 can be programmed to control the output devices to operate even when the signals generated by the proximity sensors do not indicate that the dog 100 is approaching an object. For example, a property owner who owns the dog 100 may desire the sensor system 101 to create artificial boundaries corresponding to the boundaries of the property, to ensure the dog 100 does not escape or accidentally leave the property. In such cases, the control unit 122 can be provided with data representative of the boundaries of the property, and can monitor signals generated by the GPS module to determine how close the dog 100 is to the boundaries. If the signals generated by the GPS module indicate that the dog 100 has reached such a boundary, then the control unit 122 can control the output devices to provide tactile feedback to the dog 100 to guide the dog 100 back away from the boundary and to remain within the property.

In yet other implementations, the systems described herein include no components coupled to the head of the dog 100 above its neck where a collar would ordinarily sit. In some implementations, the systems described herein include no acoustic devices. In particular, in some implementations, the systems described herein do not include any acoustic proximity sensors and do not include any acoustic output devices, but rather use vibrational or other tactile output devices. While the systems described herein are described as being used primarily with dogs, the systems described herein can be used with other animals as well, including humans, primates such as chimpanzees, other pets such as cats, and other work animals or farm animals such as horses, donkeys, mules, cows, and pigs.

The various embodiments described above can be combined to provide further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A wearable sensor device to assist a vision-impaired dog in navigating its surroundings, comprising:
a harness;
a first proximity sensor coupled to the harness at a first position that overlays a left shoulder of the dog and such that the first proximity sensor faces forward when the dog wears the harness; and
a second proximity sensor coupled to the harness at a second position that overlays a right shoulder of the dog and such that the second proximity sensor faces forward when the dog wears the harness.

2. The wearable sensor device of claim 1 wherein the first and second proximity sensors are coupled to the harness such that the first and second proximity sensors are oriented horizontally when the dog wears the harness.

3. The wearable sensor device of claim 1, further comprising:
a first output device coupled to the harness adjacent to the first proximity sensor; and
a second output device coupled to the harness adjacent to the second proximity sensor.

4. The wearable sensor device of claim 3, further comprising:
a third proximity sensor coupled to the harness at a third position that overlays a left side of a torso of the dog and such that the third proximity sensor faces away from the left side of the dog when the dog wears the harness; and
a fourth proximity sensor coupled to the harness at a fourth position that overlays a right side of the torso of the dog and such that the fourth proximity sensor faces away from the right side of the dog when the dog wears the harness.

5. The wearable sensor device of claim 4 wherein the third and fourth proximity sensors are coupled to the harness such that the third and fourth proximity sensors are oriented horizontally when the dog wears the harness.

6. The wearable sensor device of claim 4, further comprising:
a third output device coupled to the harness adjacent to the third proximity sensor; and
a fourth output device coupled to the harness adjacent to the fourth proximity sensor.

7. The wearable sensor device of claim 6, further comprising:
a fifth proximity sensor coupled to the harness at a fifth position that overlays a chest of the dog and such that the fifth proximity sensor faces forward when the dog wears the harness.

8. The wearable sensor device of claim 7 wherein the fifth proximity sensor is coupled to the harness such that the fifth proximity sensor is oriented horizontally when the dog wears the harness.

9. The wearable sensor device of claim 7, further comprising:
a fifth output device coupled to the harness adjacent to the fifth proximity sensor.
